(19) United States
(12) Patent Application Publication
(10) Pub. No.: US 2011/0299840 A1
(43) Pub. Date: Dec. 8, 2011

(54) ELECTRICAL WATER HEATING SYSTEM

(75) Inventor: Ytsen Wielstra, Drachten (NL)

(73) Assignee: KONINKLIJKE PHILIPS ELECTRONICS N.V., EINDHOVEN (NL)

(21) Appl. No.: 13/202,598

(22) PCT Filed: Feb. 23, 2010
(86) PCT No.: PCT/IB10/50786

§ 371 Date: Aug. 22, 2011

(30) Foreign Application Priority Data
Mar. 2, 2009 (EP) 09154069

(51) Int. Cl. H05B 3/78; D06F 75/08; D06F 39/04; F24H 1/18

(52) U.S. Cl. 392/497; 392/441; 219/438; 38/82; 68/12.15

(57) ABSTRACT

An electric water heating system (101) with limited scale precipitation comprises a container (102) for receiving water and defining an inner storing space for water to be heated. The water stored in said inner storing space can be heated by an electric heating element (104) present in the inner storing space. Furthermore, an anode element (105) and a cathode element (106) are provided, either connected to or connectable to a DC power source (107) to create a potential difference between the cathode element (106) and the anode element (105). The cathode element (106) is located in the inner storing space adjacent to the heating element (104).

### FIELD OF THE INVENTION

The invention relates to an electric water heating system comprising a container for receiving water and defining an inner storing space for water to be heated, having an electric heating element for heating the water stored in said inner storing space, and an anode element and a cathode element connected or connectable to a DC power source to create a potential difference between the cathode element and the anode element. The invention further relates to an electric water heating system comprising a hollow body for conducting water to be heated, having an inner wall, an electric heating element for heating the water attached to said inner wall, and an anode element and a cathode element connected or connectable to a DC power source to create a potential difference between the cathode element and the anode element.

The invention further relates to a water kettle comprising an electric water heating system.

The invention further relates to a coffee maker comprising an electric water heating system.

The invention further relates to an iron comprising an electric water heating system.

The invention further relates to a washing machine comprising an electric water heating system.

### BACKGROUND OF THE INVENTION

As is generally known, scale, typically calcium carbonate, is formed in water heating systems during use of such systems. The basic chemical reaction involved is: Ca(HCO₃)₂→CaCO₃+CO₂+H₂O. Especially water of high hardness has a high tendency to form scale deposits. The most important elements dissolved in water and responsible for hardness are Ca²⁺-ions, Mg²⁺-ions and HCO₃⁻-ions. Total hardness of water (DH) is defined as the total number of millimol Ca²⁺-ions and Mg²⁺-ions per liter multiplied by 5.6. The temporary hardness is defined by the number of millimol HCO₃⁻-ions per liter times 2.8.

The solubility of scale in water decreases with increasing temperature. Consequently, especially hot surfaces like heating elements are susceptible to be covered by scale. Furthermore, scale has a preference to precipitate on metal surfaces. In typical electric water heating systems the heating element is made of metal. Such a metal water heating element is very susceptible for scale to precipitate as it combines during operational use a metal surface and a hot surface. Scale deposition on the heating element reduces the thermal efficiency of the heating element and therefore the overall efficiency of the electric water heating system.

In the art, electrochemical approaches have been proposed to prevent the precipitation of scale on the heating element. For example U.S. Pat. No. 6,871,014 B2 discloses an electrical water heater with so-called cathodic prevention. Cathodic prevention is a generally used name for the concept of controlling the corrosion of a metal surface by making it work as a cathode of an electrochemical cell. In the context of U.S. Pat. No. 6,871,014 B2 cathodic prevention is implemented by creating a potential difference between a water heater inner wall and the heating element, in which the water heater inner wall acts as a cathode element and the heating element as an anode element. In this arrangement, according to U.S. Pat. No. 6,871,014 B2, corrosion of the water heater inner wall is prevented as electrochemical effects prevent corrosion to occur at the water heater wall. At the same time, H⁺-ions are formed at the heating element acting as an anode element, preventing scale from being formed near the heating element. However, in this configuration the heating element is susceptible to oxidation making it necessary to be made of highly oxidation resistant metals.

As the water heater inner wall acts as a cathode element, OH⁻-ions are formed near the water heater inner wall, leading to the precipitation of scale on the water heater inner wall due to transformation of HCO₃⁻-ions into CO₃²⁻-ions. These results in a decrease of the electrical efficiency as the scale electrically insulates to a certain extend the water heater inner wall acting as a cathode element. It requires regular proper cleaning to prevent this effect. Further, the precipitated scale will result in a fouled appearance of the water heater inner wall.

### SUMMARY OF THE INVENTION

It is an object of the invention to provide an electric water heating system comprising a container for receiving water of the kind defined in the introductory paragraph, in which scale precipitation on both the heating element and the container inner wall is prevented.

The object of the invention is realized by the electric water heating system as defined in claim 1. Particularly, in the electric water heating system according to the invention the cathode element is in the inner storing space adjacent to the heating element.

In operational use, OH⁻-ions are formed at the cathode. At the same time, the hot heating element causes turbulent flow patterns in the water, especially close to the heating element. As the cathode is adjacent to the heating element, the OH⁻-ions are formed in an area of the inner storing space where turbulence is present. This causes the OH⁻-ions formed to mix with the heated water. The OH⁻-ions formed increase the pH locally and at least a part of them transform the HCO₃⁻-ions into CO₃²⁻-ions. The CO₃²⁻-ions react with the Ca²⁺-ions present in the water to form scale. The turbulence results in a good distribution of OH⁻-ions in the water. Surprisingly, scale is formed as micro-crystals only. These micro-crystals remain in the water and do not or do hardly precipitate. Due to their small size, the micro-crystals do not foul the water. Furthermore, scale is prevented to cover the heating element or the container wall.

It is to be noted that the anode element can be located in the water container, or on the water container wall, or even be integrated with the container wall. However, the anode element is not to be between the cathode element and the heating element, or provided on or integrated with the heating element.

In an advantageous embodiment the cathode element and the heating element are positioned substantially centrally in the container, thereby allowing water to flow freely around the cathode element and the heating element, having no obstacles obstructing its convection. This contributes to the proper mixing of the OH⁻-ions formed and therefore to a further prevention of scale being formed.

The DC power source can be configured to deliver a constant voltage difference between the cathode element and the anode element. However, throughout this application a DC power source is defined as a device which keeps the orientation of the voltage difference between the cathode element and the anode element constant, the value of the voltage difference can be time-dependent.

Electric water heating systems of the type of the invention can be used both in domestic applications, as in large scale industrial applications.

In a preferred embodiment of the electric water heating system according to the invention, the cathode element is provided on the heating element. This ensures that the OH⁻-ions are formed in a location where the turbulence due to the heating of the water is present, as well as water heated by the heating element. This further improves the efficiency of the formation of scale micro-crystals and thereby decreases the amount of larger sized scale particles formed, leading to an even better prevention of water fouling and scale precipitation. Also, this reduces the design and production efforts to correctly position the cathode element with respect to the heating element and reduces the design and production costs of the electric water heating system.

In a preferred embodiment of the electric water heating system according to the invention, the cathode element and the heating element are integrated into one component, such constituting an integral unit. Due to this integration, no design effort has to be invested to properly position the cathode element with respect to the heating element. This reduces design costs. Furthermore, the OH⁻-ions are formed at the heating element, further improving the efficiency of the formation of scale micro-crystals.

In a preferred embodiment of the electric water heating system according to the invention, the anode element is made of carbon. As is known from the prior art, e.g. U.S. Pat. No. 6,871,014 B2, titanium or niobium substrate with a platinum layer are to be recommended for forming the anode element. Surprisingly, experiments have shown that when using a carbon anode, the scale prevention is more efficient then when using alternative anode materials.

In a preferred embodiment of the electric water heating system according to the invention it comprises a tool for adding turbulence to the water located in a lower part of the container for adding turbulence to the water surrounding the heating element and the cathode element. The tool for adding turbulence to the water can e.g. be a stirrer or an airstream injected into the electrical water heating system. The tool for adding turbulence to the water being located in a lower part of the container means that the tool for adding turbulence to the water is in the area of the container which is typically filled with water, during use. In such a configuration the tool for adding turbulence to the water, during operational use, introduces additional turbulence in the water, additional to the turbulence resulting from the convection of heated water. This additional turbulence introduced by the tool for adding turbulence to the water contributes to the mixing of the OH⁻-ions and the water, thereby improving the efficiency of the formation of scale micro-crystals and decreasing the amount of larger sized scale particles formed, leading to even better prevention of water fouling and scale precipitation. Furthermore, as the mixing of OH⁻-ions is improved by the addition of turbulence to the water, more OH⁻-ions are allowed to be formed, e.g. by applying a higher potential difference between the anode element and the cathode element than that would be the case without adding additional turbulence to the water. As more OH⁻-ions are available in the solution, the efficiency of the scale micro-crystal formation is improved.

In a preferred embodiment of the electric water heating system according to the invention it comprises a control unit for substantially simultaneously switching the DC power source and the heating element between a first state in which the heating element is powered to heat the water and the DC power source applies a voltage difference to the anode element and the cathode element and a second state in which the heating element and the DC power source are switched off In this embodiment, there is no voltage difference between the anode element and the cathode element when the heating element is not in use. When the heating element is not in use, there will be less or no turbulence in the water. When under these circumstances a voltage difference is applied between the anode element and the cathode element, OH⁻-ions formed will not spread through the water. This will lead to an increased concentration of OH⁻-ions. Consequently, scale is formed which is most likely to precipitate on the nearby heating element. Furthermore, limiting the application of a voltage difference between the cathode element and the anode element also results in a reduced corrosion of the anode element.

In a preferred embodiment of the electric water heating system according to the invention, the anode element and the cathode element are arranged to form a substantially homogeneous electric field during operational use. Such a homogeneous electric field results in the formation of OH⁻-ions in substantially equal amounts at different parts of the cathode. The OH⁻-ions will therefore be optimally mixed by the turbulence of the water, resulting in an efficient formation of scale micro-crystals. This efficient formation of micro-crystals leads to a further reduction of scale precipitating. Furthermore, this efficient formation of scale micro-crystals results in micro-crystals which do no foul the water.

It is a further object of the invention to provide an electric water heating system comprising a hollow body for conducting water of the kind defined in the introductory paragraph, in which scale precipitation on both the heating element and the container inner wall is prevented.

The further object of the invention is realized by the electric water heating system as defined in claim 2. Particularly, in the electric water heating system according to the invention the cathode element is attached to the inner wall adjacent to the heating element.

In operational use, OH⁻-ions are formed at the cathode. At the same time, the hot heating element causes turbulent flow patterns in the water, especially close to the heating element. As the cathode is adjacent to the heating element, the OH⁻-ions are formed in an area of the inner space where turbulence is present. This causes the OH⁻-ions formed to mix with the heated water. The OH⁻-ions formed increase the pH locally and at least a part of them transform the HCO₃⁻-ions into CO₃²⁻-ions. The CO₃²⁻-ions react with the Ca²⁺-ions present in the water to form scale. The turbulence results in a good distribution of OH⁻-ions in the water. Surprisingly, scale is formed as micro-crystals only. These micro-crystals remain in the water and do not or do hardly precipitate. Due to their small size, the micro-crystals do not foul the water.

It is to be noted that the anode element can be located in the hollow body, or on the hollow body inner wall, or even be integrated with the hollow body inner wall. However, the anode element is not to be between the cathode element and the heating element, or provided on or integrated with the heating element.

The DC power source can be configured to deliver a constant voltage difference between the cathode element and the anode element. However, throughout this application a DC power source is defined as a device which keeps the orientation of the voltage difference between the cathode element and the anode element constant, the value of the voltage difference can be time-dependent.

Electric water heating systems of the type of the invention can be used both in domestic applications, as in large scale industrial applications.

In a preferred embodiment of the electric water heating system according to the invention, the cathode element is provided on the heating element. This ensures that the OH⁻-ions are formed in a location where the turbulence due to the heating of the water is present, as well as water heated by the heating element. This further improves the efficiency of the formation of scale micro-crystals and thereby decreases the amount of larger sized scale particles formed, leading to an even better prevention of water fouling and scale precipitation. Also, this reduces the design and production efforts to correctly position the cathode element with respect to the heating element and reduces the design and production costs of the electric water heating system.

In a preferred embodiment of the electric water heating system according to the invention, the cathode element and the heating element are integrated into one component, such constituting an integral unit. Due to this integration, no design effort has to be invested to properly position the cathode element with respect to the heating element. This reduces design costs. Furthermore, the OH⁻-ions are formed at the heating element, further improving the efficiency of the formation of scale micro-crystals.

In a preferred embodiment of the electric water heating system according to the invention, the cathode element, the heating element and the inner wall are integrated into one component, such constituting an integral unit. Due to this integration, a compact electric water heating system can be designed. Also, no effort has to be invested to properly position the cathode element with respect to the heating element. This reduces design costs. Furthermore, the OH⁻-ions are formed at the heating element, further improving the efficiency of the formation of scale micro-crystals.

In alternative embodiments of the electric water heating system according to the invention, the heating element is provided on the side of the inner wall not in contact with the water, e.g. the outside of the inner wall. In such embodiments, the inner wall as a whole will heat up and de facto act as a heating element with respect to the water flowing through the electrical water heating system. In this kind of embodiments the inner wall as a whole acts as a cathode element.

In a preferred embodiment of the electric water heating system according to the invention, the anode element is made of carbon. As is known from the prior art, e.g. U.S. Pat. No. 6,871,014 B2, titanium or niobium substrate with a platinum layer are to be recommended for forming the anode element. Surprisingly, experiments have shown that when using a carbon anode, the scale prevention is more efficient then when using alternative anode materials.

In a preferred embodiment of the electric water heating system according to the invention it comprises a control unit for substantially simultaneously switching the DC power source and the heating element between a first state in which the heating element is powered to heat the water and the DC power source applies a voltage difference to the anode element and the cathode element and a second state in which the heating element and the DC power source are switched off In this embodiment, there is no voltage difference between the anode element and the cathode element when the heating element is not in use. When the heating element is not in use, there will be less or no turbulence in the water. When under these circumstances a voltage difference is applied between the anode element and the cathode element, OH⁻-ions formed will not spread through the water. This will lead to an increased concentration of OH⁻-ions. Consequently, scale is formed which is most likely to precipitate on the nearby heating element. Furthermore, limiting the application of a voltage difference between the cathode element and the anode element also results in a reduced corrosion of the anode element.

In a preferred embodiment of the electric water heating system according to the invention, the anode element and the cathode element are arranged to form a substantially homogeneous electric field during operational use. Such a homogeneous electric field results in the formation of OH⁻-ions in substantially equal amounts at different parts of the cathode. The OH⁻-ions will therefore be optimally mixed by the turbulence of the water, resulting in an efficient formation of scale micro-crystals. This efficient formation of micro-crystals leads to a further reduction of scale precipitating. Furthermore, this efficient formation of scale micro-crystals results in micro-crystals which do no foul the water.

In a preferred embodiment of the electric water heating system according to the invention, the anode element is located substantially on an axially oriented axis of the hollow body. This design is easy to implement which reduces design and production costs of the electrical water heater.

In a preferred embodiment of the electric water heating system according to the invention, the anode element is located substantially on a central axially oriented axis of the hollow body. In such an arrangement a substantially homogeneous electrical field between the anode element and the cathode element is during operational use realized without much design effort. This reduces the overall design costs of the electrical water heater.

As explained in the foregoing, similar effects are obtained in both variants, i.e. the variant described in claim 1 and the variant described in claim 2, of the electric water heating system according to the invention. Both variants rely on the same inventive thought, namely the cathode element being adjacent to the heating element, and the same working principle, namely that only scale micro-crystals are formed which do not precipitate on parts of the electric water heating system or foul the water.

It is a further object of the invention to provide a water kettle comprising a variant of the electric water heating system according to the invention.

It is a further object of the invention to provide a coffee maker comprising a variant of the electric water heating system according to the invention.

It is a further object of the invention to provide an iron comprising a variant of the electric water heating system according to the invention.

With reference to the claims it is noted that the invention also relates to all possible combinations of features and/or measures defined in the various claims.

In a typical experiment proving the effect of the invention, a beaker, acting as a container for receiving water and defining an inner storing space, was filled with 240 ml of water to be heated. The water was prepared according IEC norm 60734 and had a total hardness of 16.8 and a temporary hardness of 11.2. The pH was 8.25. In the beaker a coil-shaped electric heating element was inserted that was regulated by a thermostat. The heating element acted as a cathode element. An L-shaped electrode acting as an anode element was mounted in such a way that its lower part was sticking into the center of the coil. During the experiment a control unit powered the electric heating element and the DC power source based on the water temperature and elapsed time. The water was boiled for ten minutes, the heating element being switched on and off intermittently during this period of time. The control unit powered the DC power source when the heating element switched on only. After the experiment the water was left to cool down to ambient temperature. The water was visually inspected to assess its clarity. Furthermore, the water was filtered and the residual water was tested for hardness. The difference between the hardness before and after boiling is a good indicator of the amount of scale which precipitated or did not pass the filter. The results of the experiment are shown in the table below:

| Voltage difference applied | | | | Hardness | | |
|---|---|---|---|---|---|---|
| 0 V | 2.5 V | 3.0 V | 3.5 V | DH | Temp | Water appearance |
| 0 sec | | | | 16.8 | 11.0 | |
| 10 min | | | | 10.6 | 4.4 | Turbid |
| | 10 min | | | 13.3 | 6.5 | Clear |
| | | 10 min | | 14.1 | 7.6 | Clear |
| | | | 10 min | 14.3 | 7.5 | Clear |

The first line shows the hardness of the water before boiling. The second line shows, as a reference, the water boiled without the application of a voltage. From the sharp decrease in the hardness of the water it is clear that quite some scale was formed. This was also visible as the boiled water appeared turbid.

When a voltage difference was applied to the anode element and the cathode element of 2.5V or more, the hardness of the boiled water gets closer to the hardness of the untreated water, indicating the effective prevention of scale formed. At the same time the water remained clear and the heating element remained clean.

The voltages used in this example experiment are valid in this specific experimental set-up. Different voltages may be needed in different set-ups. Not only size of the cathode element and of the anode element play a role, but also for example the hardness and the pH of the water. It has been observed during other experiments that for hard water with a relative low pH a higher voltages are needed to obtain clear water after boiling. The higher voltage is needed to generate more O⁻-ions to compensate for the pH of the solution. Water with a higher starting pH requires a lower voltage as the concentration of OH⁻-ions to generate the scale micro-crystals is achieved earlier.

### BRIEF DESCRIPTION OF THE DRAWINGS

A detailed description of the invention is provided below. The description is provided by way of a non-limiting example to be read with reference to the drawings in which:

FIG. 1 shows a schematic cut-through of a first embodiment of an electric water heating system according to the invention comprising a container to receive water, seen according to a side perspective.

FIG. 2 shows a schematic cut-through of a second embodiment of an electric water heating system according to the invention containing a hollow body for conducting water, seen according to a front perspective.

FIG. 3 shows a schematic cut-through of the second embodiment of an electric water heating system as shown in FIG. 2, seen according to a side perspective.

FIG. 4 shows a schematic cut-through of a third embodiment of an electric water heating system according to the invention containing a hollow body for conducting water, seen according to a front perspective.

FIG. 5 shows a schematic cut-through of the third embodiment of an electric water heating system as shown in FIG. 4, seen according to a side perspective.

### DETAILED DESCRIPTION OF THE EMBODIMENTS

In figures showing the same embodiment or the same parts thereof, the same numbers are used for the same parts.

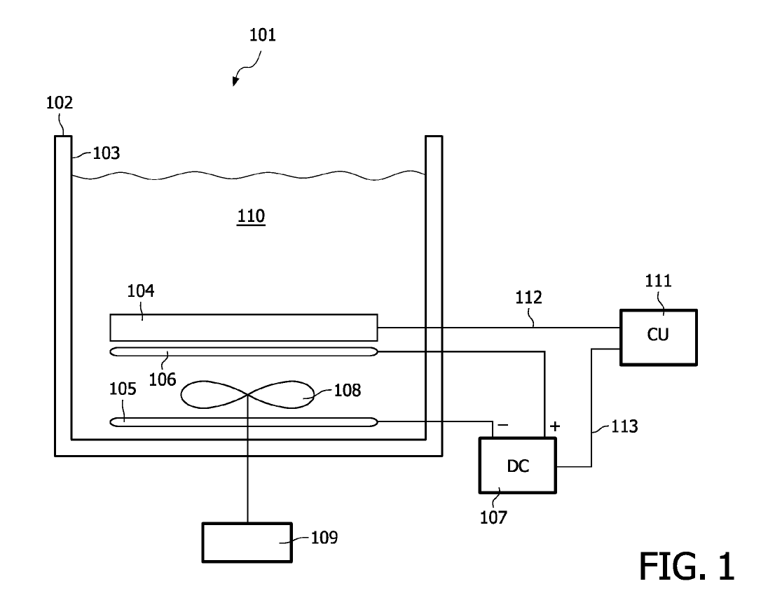

FIG. 1 shows an electric water heating system 101. The electric water heating system 101 comprises a container 102 having an inner wall 103. The container can be a cylindrical container or can be of any other suitable shape, such a box-like. The container's inner wall 103 defines an inner storing space 110 of the container. The inner wall 103 can be in contact with the water to be heated, either in total or partially, depending on the amount of water being stored in the container inner storing space. In the container inner storing space a heating element 104 is provided which can be switched on and off by a control unit 111. Not shown in FIG. 1 is that the control unit 111 can be connected to a switch operated by a user, and/or can receive a signal from any other source, e.g. a process controller, a thermostat or a vapor switch indicating the water is boiling, such a signal indicating that a switching action has to be performed. Also not shown in FIG. 1 is that the control unit can be connected to a power supply, e.g. mains electricity or some form of stored energy, like a battery. When the control unit switches on the heating element 104, the power is connected to the heater element 104 via a connection 112. Heater element 104 can be any type of electrical heater element, e.g. based on electrical resistance or on induction. In this example the heater element is an elongated element. A cathode element 106 is placed adjacent to the heating element 104. In the embodiment shown in FIG. 1, the cathode element 106 is oriented substantially parallel to the heating element 104, extending along the entire length of the heating element 104. In other embodiments the cathode element 106 can extend along only a part of the heating element 104 and/or have a different orientation. The anode element 105 is located at some distance from the cathode element 106. In this example the anode element 105 is made of carbon, in other embodiments the anode element 105 can be made of another material generally known to combine a low corrosion rate when used as an anode element 105 in water and a low solubility in water, such as titanium or niobium substrate with a platinum layer, platinum or so-called mix metal oxides. The cathode element 106 can be made of any material which has a good electrical conductivity and a low solubility in water, such as titanium, platinum, metal oxide coated titanium, or regular grades of stainless steel known to be water resistant.

In the embodiment shown in FIG. 1 an anode element 105 is oriented substantially parallel to the cathode element 106 and located near the bottom of the container. In other embodiments the anode element can be integrated with the container inner wall 103, or be located in a different location within the inner storing space and/or orientated substantially non-parallel to the cathode element 106. Both the anode element 105 and the cathode element 106 are connected to a DC power source 107. The DC power source 107 applies, during operational use, a voltage difference to the cathode element 106 and anode element 105. The DC power source 107 is switched on and off by the control unit 111. When the DC power source 107 is switched on, power is provided to the DC power source 107 by the control unit 111 via connection 113. Typically, the voltage difference between the cathode element 106 and the anode element 105 is 3.0 V when using standardized water as defined above. In other embodiments the voltage difference can be as low as 1.5 V, or exceeding 4.0 V, depending on the specific configuration of the electrical water heating system and the characteristics of the water to be heated.

Inside the inner storing space of container 102, a stirrer 108, drivable by a driving means 109 is present. The driven stirrer 108 stirs the water thereby creating additional turbulence in the heated water. In other embodiments other ways of adding extra turbulence to the water can be used, e.g. by the injection of an airflow into the water. Due to this additional turbulence, the OH⁻-ions formed at the cathode element 106 will mix very well leading to lower local concentration of OH⁻-ions. Consequently, a large number of scale micro-crystals are formed. Driving means 109 can be any known driver, e.g. an electrical motor. Not shown in FIG. 1 is the connection of the driving means 109 to its power source.

To boil water without scale precipitating on parts of the electrical water heating system 101 or fouling the water, the user fills the container 102 with the amount of water required and switches on the electrical water heating system 101 by actuating an on/off switch. This on/off switch is not shown in FIG. 1. The on/off switch sends a signal to the control unit 111. The control unit 111 evaluates this signal together with other signals acting as inputs to the control unit, e.g. control signals from a temperature sensor or a vapor sensor (both not shown in FIG. 1). When this evaluation leads to the conclusion that it is safe to power the water heater 104, the control unit 111 powers the water heater 104. Simultaneously, or at least substantially simultaneously, the control unit 111 will power the DC power source 107 as well. The powered water heater 104 will heat up and start to transfer heat to the water, eventually resulting in the water to boil. The powered DC power source 107 will create a potential difference between the anodic element 105 and the cathode element 106. Due to this potential difference, electrolysis of water will take place. At the cathode element 106 OH⁻-ions are formed, leading to a locally higher pH value. At the anode element 105 H⁺-ions will be formed, leading to a locally lower pH. In the areas with higher pH, scale will form. During operation, that is when being powered, the heating element 104 will cause water to flow away from it, usually in a turbulent manner. As the cathode element 106 is adjacent to the heating element 104, it will be in the area of turbulent flow. Due to this turbulence the OH⁻-ions formed will mix very well with the water. Scale is first formed at the molecular level (e.g. CaCO₃ and/or MgCO₃). Various scale molecules will aggregate together and form a microcrystal. When enough OH⁻-ions are present, such a microcrystal will grow further and reach a size that it becomes visible for the human eye. Also, larger scale crystals are likely to precipitate. In the electrical water heating system of the invention as shown in this embodiment, however, the good distribution of OH⁻-ions prevents the growth of scale crystals beyond the microcrystal size. The scale therefore remains invisible in the water and does not precipitate. To further improve the distribution of OH⁻-ions in the water, stirrer 108 powered by stirrer driving means 109 stirs the water. In a preferred embodiment the driving means 109 is also connected to the control unit 111 and is switched on and off substantially simultaneously with the heating element 104 and the DC power source 107. When the water has reached a preset temperature or e.g. its boiling point an appropriate sensor will send a signal to the control unit 111 which in turn will disable the heating element 104 and the DC power source 107. The user can pour the water out of the container and use the heated water to e.g. make tea or soup.

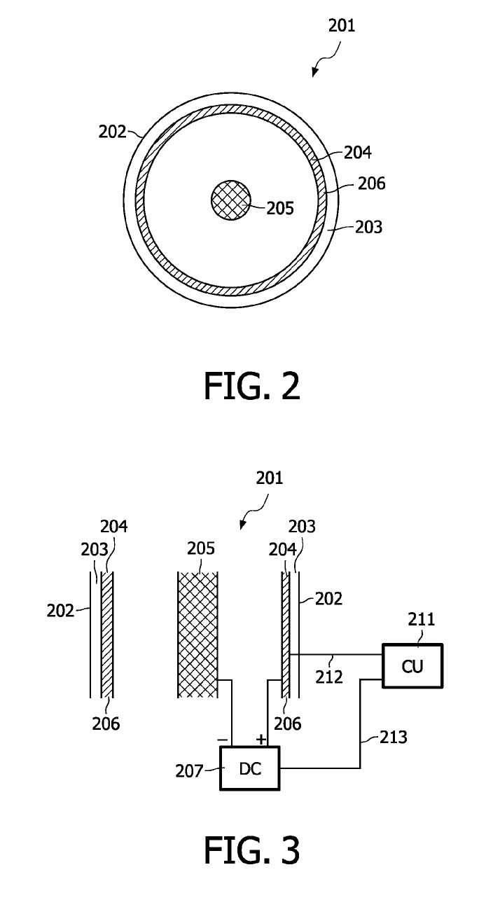

FIGS. 2 and 3 show an electric water heating system 201. The electrical water heating system 201 has a tube-like form; the cut-through shown in FIG. 2 is taken perpendicular to the axis of the tube. The cut-through shown in FIG. 3 is taken in a plane including the axis of the tube. The electric water heating system 201 has a hollow body 202 having an inner wall 203. Instead of a circle-cylindrical cross-section, the hollow body can have any suitable cross-section, such as a square or triangular cross-section. In general, heaters according to this principle are known as flow-through heaters. A heating element 204 is attached to the inner wall 203. Integrated with the heating element 204 is a cathode element 206 (not separately visible in FIG. 2). An anode element 205 is positioned near the axis of the tube-like electric water heating system 201. The anode element 205 is held in position by e.g. the use of end stoppers that have an opening in which the anode element can be fixed. The anode element 205 and the cathode element 206 are connected to a DC power source 207 as illustrated in FIG. 3. Both the heating element 204 and the DC power source 207 are connected to a control unit 211. Not shown in FIG. 3 is that the control unit 211 can be connected to a switch operated by a user, and/or can receive a signal from any other source, e.g. a process controller or a flow sensor indicating the water is streaming through the electric water heating system 201, such a signal indicating that a switching action has to be performed. Also not shown in FIG. 3 is that the control unit can be connected to a power supply, e.g. mains electricity or some form of stored energy, like a battery. When the control unit 211 switches on the heating element 204, the power is connected to the heater element 204 via a connection 212. Heater element 204 can be any type of electrical heater element, e.g. based on electrical resistance or on induction. In this example the heater element is an elongated element. A cathode element 206 is integrated with heating element 204. In other embodiments, the cathode element 206 can be attached to or even be separated from the heating element 204. The anode element 205 is located at some distance from the cathode element 206. In this example the anode element 205 is made of carbon, in other embodiments the anode element 205 can be made of another material generally known to combine a low corrosion rate when used a an anode element 205 in water and a low solubility in water, such as titanium or niobium substrate with a platinum layer, platinum or so-called mix metal oxides. The cathode element 206 can be made of any material which has a good electrical conductivity and a low solubility in water, such as titanium, platinum, metal oxide coated titanium, or regular grades of stainless steel known to be water resistant

In the embodiment shown in FIGS. 2 and 3 an anode element 205 is oriented substantially parallel to the axis of revolution of the tube-like electric water heating system 201. In other embodiments the anode element can have different orientations and/or can be placed away from a central axially oriented axis of the hollow body. Both the anode element 205 and the cathode element 206 are connected to a DC power source 207. The DC power source 207 applies, during operational use, a voltage difference to the cathode element 206 and anode element 205. The DC power source 207 is switched on and off by the control unit 211. When the DC power source 207 is switched on, power is provided to the DC power source 207 by the control unit 211 via connection 213. Typically, the voltage difference between the cathode element 206 and the anode element 205 is 3.0 V when using standardized water as defined above. In other embodiments the voltage difference can be as low as 1.5 V, or exceeding 4.0 V, depending on the specific configuration of the electrical water heating system and the characteristics of the water to be heated.

During operational use, when the electrical water heating system 201 is in use to heat up or boil water flowing through the hollow body 202 without scale precipitating on parts of the electrical water heating system 201 or fouling the water, the control unit 211 powers the water heater 204. Simultaneously, or at least substantially simultaneously, the control unit 211 will power the DC power source 207 as well. The powered water heater 204 will heat up and start to transfer heat to the water, eventually resulting in the water to boil. The powered DC power source 207 will create a potential difference between the anodic element 205 and the cathode element 206. Due to this potential difference, electrolyses of water will take place. At the cathode element 206 OH⁻-ions are formed, leading to a locally higher pH value. At the anode element 205 H⁺-ions will be formed, leading to a locally lower pH. In the areas with higher pH, scale will form. Scale is first formed at the molecular level (e.g. CaCO₃ and/or MgCO₃). Various scale molecules will aggregate together and form a microcrystal. When enough OH⁻-ions are present, such a microcrystal will grow further and reach a size that it becomes visible for the human eye. Also, larger scale crystals are likely to precipitate. In the electrical water heating system of the invention as shown in this embodiment, however, the good distribution of OH⁻-ions prevents the growth of scale crystals beyond the microcrystal size. The scale therefore remains invisible in the water and does not precipitate. When there is no further requirement for heated up or boiled water, a process controller or the like will send a signal to the control unit 211 which in turn will disable the heating element 204 and the DC power source 207.

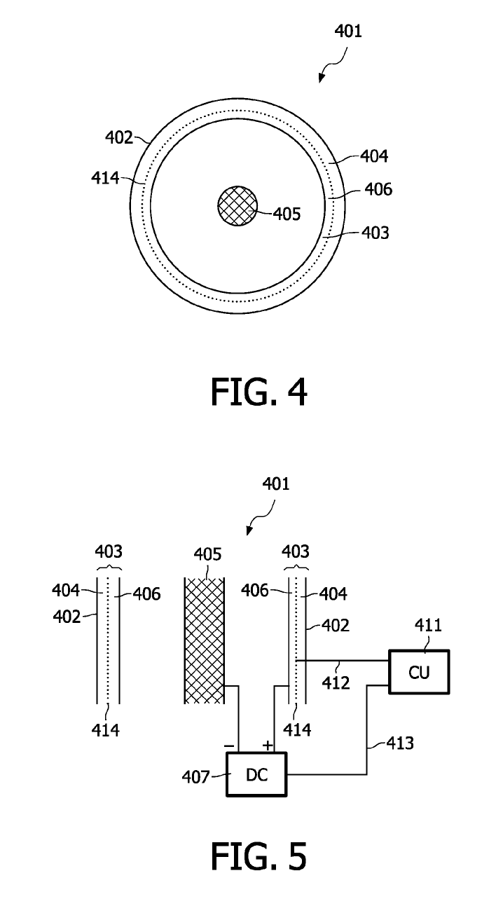

The embodiment shown in FIGS. 4 and 5 differs from that of FIGS. 2 and 3 in the aspect that the heating element, the inner wall and the cathode element are integrated into one component. FIGS. 4 and 5 show an electric water heating system 401. The electrical water heating system 401 has a tube-like form; the cut-through shown in FIG. 4 is taken perpendicular to the axis of the tube. The cut-through shown in FIG. 5 is taken in a plane including the axis of the tube. The electric water heating system 401 has a hollow body 402 having an inner wall 403. A heating element 404 is integrated with the inner wall 403. In this particular embodiment the heating element 404 is essentially on the outer side of the inner wall 403. In FIGS. 4 and 5 the area in which the heating element 404 is present is delimited by dashed line 414. Integrated with the inner wall 203 is a cathode element 406 (not separately visible in FIG. 4). An anode element 405 is positioned near the axis of the tube-like electric water heating system 401. The anode element 405 and the cathode element 406 are connected to a DC power source 407 as illustrated in FIG. 5. Both the heating element 404 and the DC power source 407 are connected to a control unit 411. The DC power source 407 and the control unit 411 operate similar to those of FIGS. 2 and 3. During operational use, the electrical water heating systems 201 and 401 are operated similarly.

While the invention has been illustrated and described in detail in the drawings and in the foregoing description, the illustrations and the description are to be considered illustrative or exemplary and not restrictive. The invention is not limited to the disclosed embodiments. It is noted that the electric water heating system according to the invention and all its components can be made by applying processes and materials known per se. In the set of claims and the description the word “comprising” does not exclude other elements and the indefinite article “a” or “an” does not exclude a plurality. Any reference signs in the claims should not be construed as limiting the scope. It is further noted that all possible combinations of features as defined in the set of claims are part of the invention.

### LIST OF REFERENCE NUMERALS

101 electrical water heating system
102 container
103 container inner wall
104 heating element
105 anode element
106 cathode element
107 DC power source
108 stirrer
109 driving means
110 container inner storing space
111 control unit
112 connection between control unit and heating element
113 connection between control unit and DC power source
201 electrical water heating system
202 hollow body
203 inner wall
204 heating element integrated with cathode element
205 anode element
206 cathode element
207 DC power source
211 control unit
212 connection between control unit and heating element
213 connection between control unit and DC power source
401 electrical water heating system
402 hollow body
403 inner wall
404 heating element integrated with the inner wall
405 anode element
406 cathode element integrated with the inner wall
407 DC power source
411 control unit
412 connection between control unit and heating element
413 connection between control unit and DC power source
414 border between the heating element and the remainder of the inner wall

1. An electric water heating system (101) comprising
a container (102) for receiving water and defining an inner storing space for water to be heated, having
an electric heating element (104) for heating the water stored in said inner storing space, and
an anode element (105) and a cathode element (106) connected or connectable to a DC power source (107) to create a potential difference between the cathode element (106) and the anode element (105),
characterized in that the cathode element (106) is located in the inner storing space adjacent to the heating element (104).

2. An electric water heating system (201, 401) comprising
a hollow body (202, 402) for conducting water to be heated, having
an inner wall (203, 403),
an electric heating element (204, 404) for heating the water attached to said inner wall, and
an anode element (205, 405) and a cathode element (206, 406) connected or connectable to a DC power source (207, 407) to create a potential difference between the cathode element (206, 406) and the anode element (205, 405),
characterized in that the cathode element (206, 406) is attached to the inner wall (203, 403) adjacent to the heating element (204, 404).

3. An electric water heating system (101, 201, 401) according to claim 1, characterized in that the cathode element (106, 206, 406) is provided on the heating element (104, 204, 404).

4. An electric water heating system (101, 201, 401) according to claim 1, characterized in that the cathode element (106, 206,406) and the heating element (104, 204, 404) are integrated into one component.

5. An electric water heating system (201, 401) according to claim 2, characterized in that the cathode element (206, 406), the heating element (204, 404) and the inner wall (203, 403) are integrated into one component.

6. An electric water heating system according to claim 2, characterized in that the anode element (105, 205, 405) is made of carbon.

7. An electric water heating system (101) according to claim 1, comprising a tool for adding turbulence to the water (108) located in a lower part of the container for adding turbulence to the water surrounding the heating element (104) and the cathode element (106).

8. An electric water heating system (101, 201, 401) according to claim 1, comprising a control unit (111, 211, 411) for substantially simultaneously switching the DC power source (107, 207, 407) and the heating element (104, 204, 404) between a first state in which the heating element (104, 204, 404) is powered to heat the water and the DC power source (107, 207, 407) applies a voltage difference to the anode element (105, 205, 405) and the cathode element (106, 206, 406) and a second state in which the heating element (104, 204, 404) and the DC power source (107, 207, 407) are switched off.

9. An electric water heating system (101, 201, 401) according to claim 1, characterized in that the anode element (105, 205, 405) and the cathode element (106, 206, 406) are arranged to form a substantially homogeneous electric field during operational use.

10. An electric water heating system (201, 401) according to claim 2, characterized in that the anode element (205, 405) is located substantially on an axially oriented axis of the hollow body.

11. An electric water heating system (201, 401) according to claim 2, characterized in that the anode element (205, 405) is located substantially on a central axially oriented axis of the hollow body.

12. A water kettle comprising an electric water heating system according to claim 1.

13. A coffee maker comprising an electric water heating system according to anyone of the claims 1.

14. An iron comprising an electric water heating system according to anyone of the claims 1.

15. A washing machine comprising an electric water heating system according to anyone of the claims 1.
